(19) United States
(12) Patent Application Publication
(10) Pub. No.: US 2026/0253323 A1
(43) Pub. Date: Aug. 27, 2026

(54) METHOD FOR PROVIDING INTERACTIVE RESPONSE, HOST, AND COMPUTER READABLE STORAGE MEDIUM

(71) Applicant: HTC Corporation, Taoyuan City (TW)

(72) Inventor: Chang-Chen Yao, Taoyuan City (TW)

(73) Assignee: HTC Corporation, Taoyuan City (TW)

(21) Appl. No.: 19/059,286

(22) Filed: Feb. 21, 2025

(51) Int. Cl. G06T 17/00; G06V 20/70

(52) U.S. Cl. CPC G06T 17/00; G06V 20/70

(57) ABSTRACT

The embodiments of the disclosure provide a method for providing interactive response, a host, and a computer readable storage medium. The method includes: providing a virtual environment, wherein the virtual environment includes a plurality of objects, and each of the plurality of objects has a corresponding descriptor; detecting a first field of view in the virtual environment, wherein the first field of view is a current field of view; determining, among the plurality of objects, a plurality of first objects in the first field of view; integrating the corresponding descriptor of each of the plurality of first objects into a first descriptor file corresponding to the first field of view; and in response to determining that a first voice input associated with the first field of view has been detected, providing a first response with respect to the first voice input based on the first descriptor file.

### BACKGROUND OF THE INVENTION

### 1. Field of the Invention

The present disclosure generally relates to a mechanism for providing response in particular, to a method for providing interactive response, a host, and a computer readable storage medium.

### 2. Description of Related Art

Currently, efforts to enable AI systems to comprehend virtual environments, such as the lobby of a VR device, largely rely on the use of screenshots. These screenshots are provided to the AI for analysis and generating inferences about the scene. However, when AI leverages image recognition techniques to interpret the content of such scenes, the results are often inaccurate or unreliable.

### SUMMARY OF THE INVENTION

Accordingly, the present disclosure is directed to a method for providing interactive response, a host, and a computer readable storage medium, which can be used to solve the above technical problem.

The embodiments of the disclosure provide a method for for providing interactive response. The method includes: providing a virtual environment, wherein the virtual environment includes a plurality of objects, and each of the plurality of objects has a corresponding descriptor; detecting a first field of view in the virtual environment, wherein the first field of view is a current field of view; determining, among the plurality of objects, a plurality of first objects in the first field of view; integrating the corresponding descriptor of each of the plurality of first objects into a first descriptor file corresponding to the first field of view; and in response to determining that a first voice input associated with the first field of view has been detected, providing a first response with respect to the first voice input based on the first descriptor file.

The embodiments of the disclosure provide a host including a storage circuit and a processor. The storage circuit stores a program code. The processor is coupled to the non-transitory storage circuit and configured to access the program code to perform: providing a virtual environment, wherein the virtual environment includes a plurality of objects, and each of the plurality of objects has a corresponding descriptor; detecting a first field of view in the virtual environment, wherein the first field of view is a current field of view; determining, among the plurality of objects, a plurality of first objects in the first field of view; integrating the corresponding descriptor of each of the plurality of first objects into a first descriptor file corresponding to the first field of view; and in response to determining that a first voice input associated with the first field of view has been detected, providing a first response with respect to the first voice input based on the first descriptor file.

The embodiments of the disclosure provide a computer readable storage medium, the computer readable storage medium recording an executable computer program, the executable computer program being loaded by a host to perform steps of: providing a virtual environment, wherein the virtual environment includes a plurality of objects, and each of the plurality of objects has a corresponding descriptor; detecting a first field of view in the virtual environment, wherein the first field of view is a current field of view; determining, among the plurality of objects, a plurality of first objects in the first field of view; integrating the corresponding descriptor of each of the plurality of first objects into a first descriptor file corresponding to the first field of view; and in response to determining that a first voice input associated with the first field of view has been detected, providing a first response with respect to the first voice input based on the first descriptor file.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 shows a schematic diagram of a host according to an embodiment of the disclosure.

FIG. 2 shows a flow chart of the providing interactive response according to an embodiment of the disclosure.

FIGS. 3A to 3C collectively shows a schematic diagram of different segments of the first descriptor file according to a first embodiment of the disclosure.

FIGS. 4A to 4C collectively shows a schematic diagram of different segments of the second descriptor file according to a second embodiment of the disclosure.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

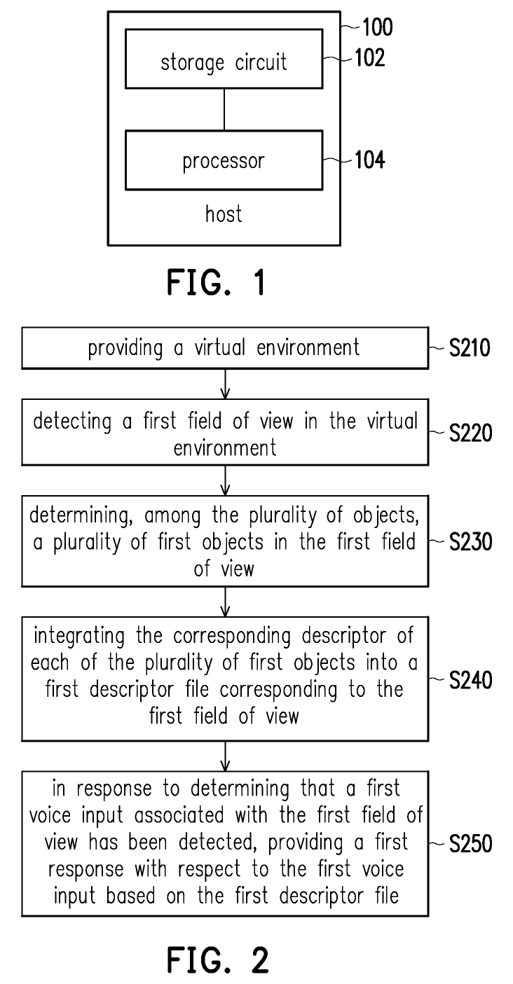

See FIG. 1, which shows a schematic diagram of a host according to an embodiment of the disclosure. In various embodiments, the host 100 can be any smart device and/or computer device that can provide visual contents of reality services such as virtual reality (VR) service, augmented reality (AR) services, mixed reality (MR) services, and/or extended reality (XR) services, but the disclosure is not limited thereto. In some embodiments, the host 100 can be a head-mounted display (HMD) capable of showing/providing visual contents (e.g., AR/VR/MR contents) for the wearer/user to see.

In one embodiment, the host 100 can be disposed with built-in displays for showing the visual contents for the user to see. Additionally or alternatively, the host 100 may be connected with one or more external displays, and the host 100 may transmit the visual contents to the external display(s) for the external display(s) to display the visual contents, but the disclosure is not limited thereto.

In FIG. 1, the host 100 includes a storage circuit 102 and a processor 104. The storage circuit 102 is one or a combination of a stationary or mobile random access memory (RAM), read-only memory (ROM), flash memory, hard disk, or any other similar device, and which records a plurality of modules that can be executed by the processor 104.

The processor 104 may be coupled with the storage circuit 102, and the processor 104 may be, for example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, a graphic processing unit (GPU), and the like.

In the embodiments of the disclosure, the processor 104 may access the modules and/or program codes stored in the storage circuit 102 to implement the method for providing interactive response proposed in the disclosure, which would be further discussed in the following.

See FIG. 2, which shows a flow chart of the providing interactive response according to an embodiment of the disclosure. The method of this embodiment may be executed by the host 100 in FIG. 1, and the details of each step in FIG. 2 will be described below with the components shown in FIG. 1.

In step S210, the processor 104 provides a virtual environment. In various embodiments, the virtual environment may refer to a digitally created, immersive space where users can interact with computer-generated elements in real time. These environments are typically characterized by high levels of interactivity, realistic or stylized 3D graphics, and spatial audio, which together create a sense of presence and immersion. Virtual environments can range from fully synthetic worlds in VR to blended spaces in AR or MR, where virtual and physical elements coexist and interact. They often include dynamic features such as user-driven navigation, object manipulation, and customizable settings, enabling a wide variety of applications across gaming, education, training, and more.

For better understanding, the virtual environment considered in the following discussions may be assumed to be a VR environment, but the disclosure is not limited thereto.

In the embodiments of the disclosure, the virtual environment includes a plurality of objects, and each of the plurality of objects has a corresponding descriptor.

In the embodiments where the virtual environment is the VR environment, the objects may be the VR objects in the VR environment, but the disclosure is not limited thereto.

In the embodiments of the disclosure, a descriptor for a object may refer to a set of metadata or attributes that define the object's properties, behavior, and interaction capabilities within the virtual environment. This may include visual characteristics such as shape, texture, color, and size, as well as functional attributes like physics properties (e.g., weight, elasticity, friction), interaction methods (e.g., grab, push, rotate), and associated sounds or animations. Descriptors may also include data related to the object's role or context in the service experience, such as its relationship with other objects, its purpose within the narrative, or any programmable behaviours triggered by user actions or environmental changes. These descriptors help ensure consistent and meaningful interactions within the virtual environment.

In some embodiments, the corresponding descriptor of one of the plurality of objects (referred to as a particular object) may include, but not limited to, at least one of following information of the particular object: a label (e.g., name), an identification (e.g., serial number), a category, a description (e.g., describing the information of the particular object), a world position, a main color (e.g., the main color of the particular object), a feature. In one embodiment, the world position of the particular object may indicate a position of the particular object in the virtual environment, such as the pose (which may be characterized in the form of 6 degree-of-freedom) of the particular object, but the disclosure is not limited thereto.

In step S220, the processor 104 detecting a first field of view in the virtual environment, wherein the first field of view is a current field of view.

In the embodiments of the disclosure, the current field of view may refer to the extent of the observable environment currently visible to the user at any given moment through the host 100 (e.g., the HMD). Since the user’s head may move from time to time, the current field of view may be varying in response to the movement of the user’s head, but the disclosure is not limited thereto.

In step S230, the processor 104 determines, among the plurality of objects, a plurality of first objects in the first field of view;

In the embodiments of the disclosure, the processor 104 may determine which of the plurality of objects are currently visible to the user based on their position and orientation in the virtual environment. This process may involve calculating whether a object's coordinates fall within the boundaries of the current field of view, considering factors such as the object's size, distance, and occlusion by other elements, but the disclosure is not limited thereto.

In step S240, the processor 104 integrates the corresponding descriptor of each of the plurality of first objects into a first descriptor file corresponding to the first field of view

In the embodiments of the disclosure, integrating the descriptors of multiple objects (e.g., the first objects) into a (single) descriptor file (e.g., the first descriptor file) may refer to creating a unified data structure that encapsulates all relevant attributes and properties of the considered objects. This file serves as a centralized repository containing information such as object geometry, textures, materials, interactive behaviours, physics properties, and any contextual metadata.

In some embodiments, the descriptor file may be often formatted in a standard schema, such as JSON, XML, or a custom format, to facilitate compatibility with the VR engine and tools used in development, but the disclosure is not limited thereto.

In some embodiments, the first descriptor file may include at least one of following information of each of the first objects: a label, an identification, a category, a description, a screen position, a world position, a main color, a feature.

In one embodiment, the screen position of each of the plurality of first objects may indicates a position of each of the plurality of first object with respect to a reference point in the first field of view, where the reference point may be the center point of the first field of view and/or other point preferred by the designer. In addition, the world position of each of the plurality of first objects may indicate a position of each of the plurality of first object in the virtual environment.

In one embodiment, the first descriptor file may further include a first set indicating the plurality of first objects in the first field of view, and a second set indicating other objects not in the first field of view. In some embodiments, the first set may include the descriptors of the first objects in the first field of view, and the second set may include the descriptors of other objects not in the first field of view, but the disclosure is not limited thereto.

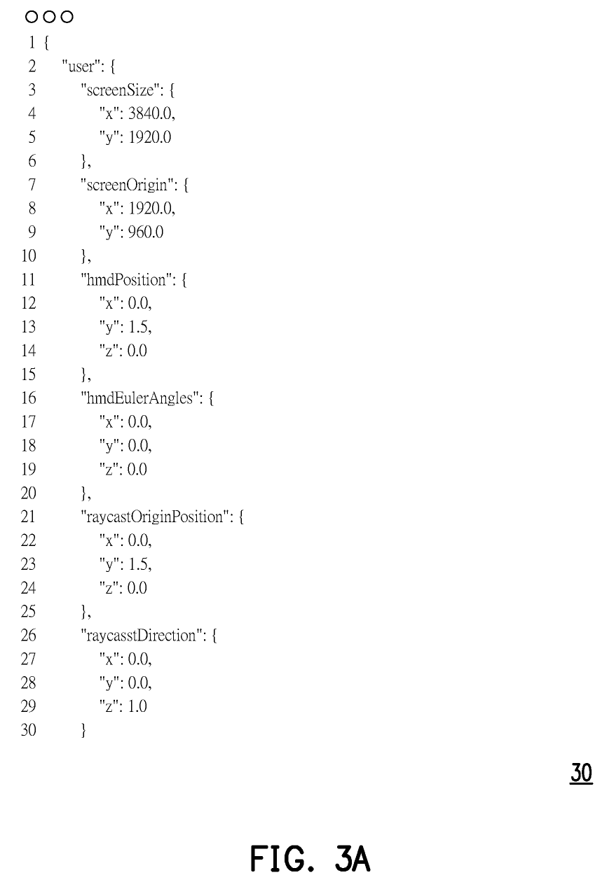

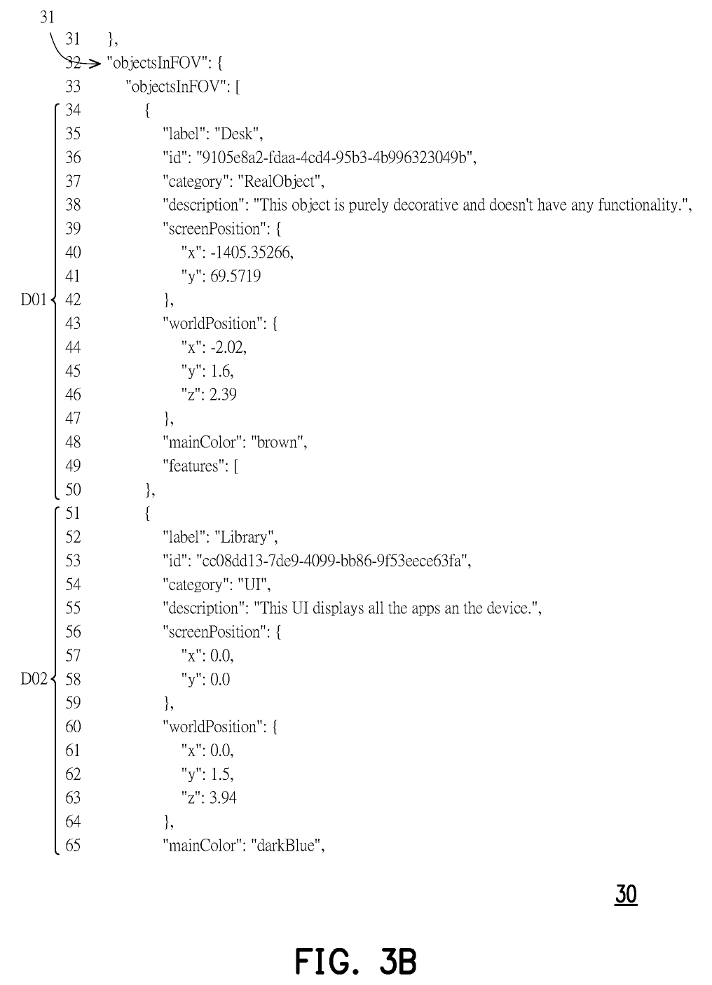

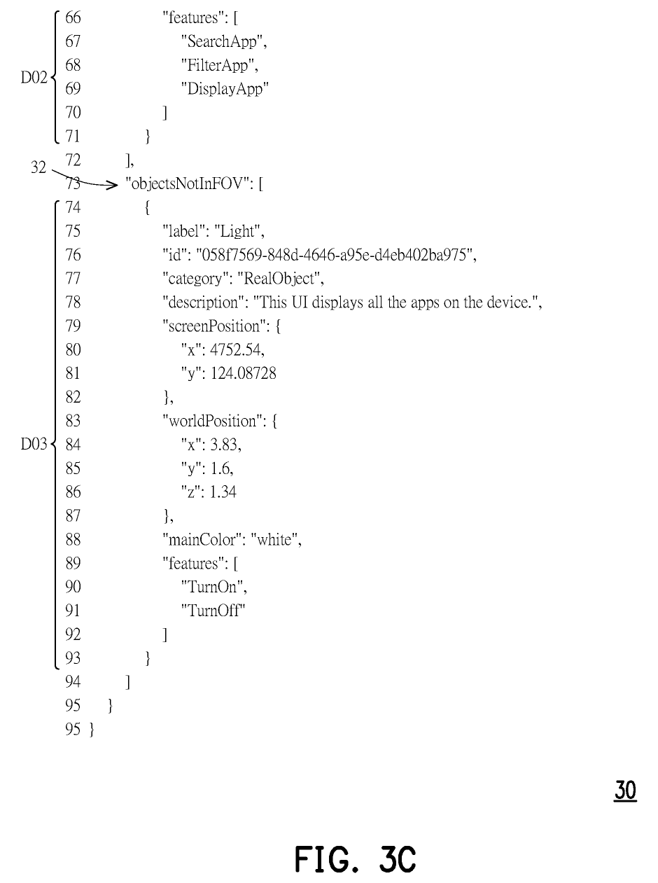

For better understanding, FIGS. 3A to 3C would be used as an example, wherein FIGS. 3A to 3C collectively shows a schematic diagram of different segments of the first descriptor file according to a first embodiment of the disclosure.

In the first embodiment, the objects in the virtual environment may be assumed to include a desk object, a library object, and a light object. In the scenario of FIGS. 3A to 3C, the considered first objects in the first field of view may be assumed to merely include the desk object and the library object. That is, the light object is assumed to be currently not in the field of view, but the disclosure is not limited thereto.

In this case, the processor 104 may integrate the descriptor D01 of the desk object and the descriptor D02 of the library object into the first descriptor file 30, which may be a JSON file.

Specifically, as can be seen from FIGS. 3B and 3C, the first descriptor file 30 may include a first set 31 and a second set 32, wherein the first set 31 indicates the desk object and the library object in the first field of view, and the second set 32 indicates the light object not in the first field of view.

In the embodiment, the first set 31 may include the descriptors D01 and D02, and the second set 32 may include the descriptor D03 of the light object. The definition of each parameter in the descriptors D01, D02, and D03 may be referred to the above discussions, which would not be repeated herein.

In some embodiments, the first descriptor file 30 may not include the second set 32, but the disclosure is not limited thereto.

In the embodiments of the disclosure, the processor 104 may detect the input voice. In this case, detecting input voice may refer to the process of capturing and interpreting a user's spoken commands or conversational input through a microphone integrated into the host 100. This involves using voice recognition algorithms to process the audio signal, convert it into text or commands, and map it to specific actions or responses within the virtual environment. This feature enables hands-free interaction, enhancing accessibility and immersion by allowing users to control the VR experience or communicate with virtual agents and other users naturally. Advanced implementations may include natural language processing (NLP) to understand context, intent, and complex queries, but the disclosure is not limited thereto.

In step S250, in response to determining that a first voice input associated with the first field of view has been detected, the processor 104 provides a first response with respect to the first voice input based on the first descriptor file.

In one embodiment, the first voice input associated with the first field of view may be the input voice from the user when the current field of view is the first field of view. That is, when the user is seeing the first field of view and provide an input voice, this input voice may be regarded as the first input voice, but the disclosure is not limited thereto.

In one embodiment, the processor 104 may generate a first prompt combination at least based on the first descriptor file and the first voice input. For example, the processor 104 may generate the first prompt combination based on the first descriptor file (which may be a JSON file), the first voice input, and a pre-prompt, wherein the pre-prompt may request to answer the first voice input based on the first descriptor file.

In the first embodiment where the desk object and the library object are in the first field of view, the first descriptor file in the first prompt combination may be the first descriptor file 30 in FIGS. 3A to 3C. In addition, the first voice input may be, for example, “What’s behind the library in front of me?”. The pre-prompt may be, for example, “Answer my question based on this JSON, carefully checking the description. Respond in a conversational way, sticking only to the question. Don’t elaborate or mention coordinates—just give a casual direction-based answer”, but the disclosure is not limited thereto.

Next, the processor 104 may input the first prompt combination to a virtual assistant to trigger the virtual assistant to provide the first response.

In the embodiments of the disclosure, a virtual assistant may refer to an AI-powered software agent designed to assist users by performing tasks or providing services based on voice, text, or other input methods. In virtual environments, a virtual assistant can guide users through the experience, offer contextual help, or execute commands such as adjusting settings, retrieving information, or interacting with other objects. These assistants are often equipped with natural language processing capabilities, enabling them to understand and respond to user queries in a conversational manner, but the disclosure is not limited thereto.

In various embodiments, the virtual assistant may use large language models (e.g., ChatGPT, Gemini, etc.) to generate the first response, but the disclosure is not limited thereto.

In the above example associated with the first embodiment, the virtual assistant may firstly parse the first descriptor file 30 to find the information (e.g., the descriptor D02) associated with the library object and determine which of the first objects is behind the library object based on, for example, the screen position in each descriptor in the first set 31.

In the first embodiment, the virtual assistant may determine the desk object is behind the library object based on the screen position in each of the descriptors D01 and D02. In this case, the possible first response with respect to the first voice input of “What’s behind the library in front of me?” may be, for example, “There's a desk behind the library in front of you”, but the disclosure is not limited thereto.

In some embodiments, the first input voice may request to execute a first function. In this case, the virtual assistant may be triggered to provide the first response by executing the first function requested by the first voice input.

In some embodiments, the first function requested by the first voice input may involve to control a target object among the plurality of first objects, such as “launching this APP”. Since this type of input voice highly depending on the indicator position of the input indicator in the first field of view, the first prompt combination may further include the indicator position of the input indicator in the first field of view.

In various embodiments, the input indicator may be, for example, a visual cue or signal that represents the user's input status or interaction, such as a cursor and/or a raycast. In some embodiments, the input indicator may include: controller indicators, which show actions performed with handheld controllers (e.g., VR controllers), such as button presses or joystick movements; hand tracking indicators, which display gestures like tapping, grabbing, or swiping when using hand tracking features; voice input indicators, such as microphone icons or wave animations, to signal that voice input is being received or processed; eye tracking indicators, which highlight the user's gaze point or selection area in eye-tracking interactions; virtual keyboard indicators, showing the current focus or input location, like a cursor or key highlight during text input; and activation indicators, signaling that a function is being triggered or input has been received, often through icons or color changes during object selection or drag-and-drop actions, but the disclosure is not limited thereto.

In this case, the virtual assistant may be triggered to determine the target object by parsing the first descriptor file based on the indicator position. In one embodiment, the virtual assistant may parse the descriptors in the first descriptor file to find which of the first objects in the first field of view is most likely to be the target object required by the user.

For example, the virtual assistant may retrieve the screen position in each descriptor in the first descriptor file to determine which of the first objects in the first field of view is closest to the indicator position, and determine it as the target object, but the disclosure is not limited thereto.

Next, the virtual assistant may execute the first function by controlling the target object as requested by the first voice input. For example, the virtual assistant may execute the first function by launching the application closest to the indicator position, but the disclosure is not limited thereto.

In one embodiment, if the first objects in the first field of view include a certain object at the lower right of the first field of view, the user may provide the first input voice such as “What’s the thing at the lower right corner in the screen?”. In this case, the virtual assistant may infer that the certain object is the target object based on, for example, the screen position in the associated descriptor in the first descriptor filed. Next, the virtual assistant may provide the first response by providing the introduction of the certain object, but the disclosure is not limited thereto.

In one embodiment, if the first objects in the first field of view include a search application, a filter application, a display application, and an open application, the processor 104 may accordingly determine the corresponding first descriptor file. In this case, the user may provide the first input voice such as “What can I do with the UI in front of me right now?”. In this case, the first response may involve the introductions to each application currently in the first field of view, but the disclosure is not limited thereto.

In one embodiment, the considered virtual environment may be an MR environment, and the objects therein may be MR objects. In the embodiment, each MR object may be designed with the corresponding descriptor.

In the embodiment where the virtual environment is the MR environment, if the first object in the first field of view is a real lamp (which has a corresponding descriptor), the associated first descriptor file may accordingly include the corresponding descriptor of the real lamp. In this case, the user may provide the first input voice such as “Turn on the light”. In this case, the first response may involve sending the associated controlling command to the application for managing the real lamp, such that the real lamp can be turned off, but the disclosure is not limited thereto.

In some embodiments, step S240 may be performed after detecting the first voice input associated with the first field of view. That is, the processor 104 may determine whether the first voice input is detected after step S230. In response to determining that the first voice input associated with the first field of view is detected, the processor 104 may accordingly generate the first descriptor file as discussed in step S240, and provide the first response with respect to the first voice input based on the first descriptor file, but the disclosure is not limited thereto.

In the embodiments of the disclosure, since the current field of view of the user to the virtual environment may vary from time to time, the processor 104 may dynamically generate the descriptor filed corresponding to the current field of view.

For example, in response to determining that the current field of view has been changed from the first field of view to a second field of view, the processor 104 may determine, among the plurality of objects, a plurality of second objects in the second view of view. Next, the processor 104 may integrate the corresponding descriptor of each of the plurality of second objects into a second descriptor file.

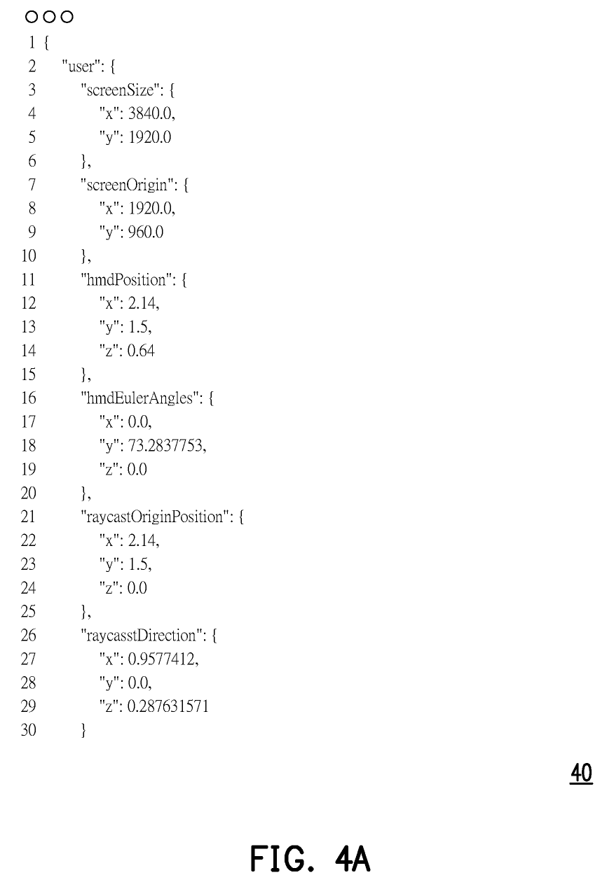

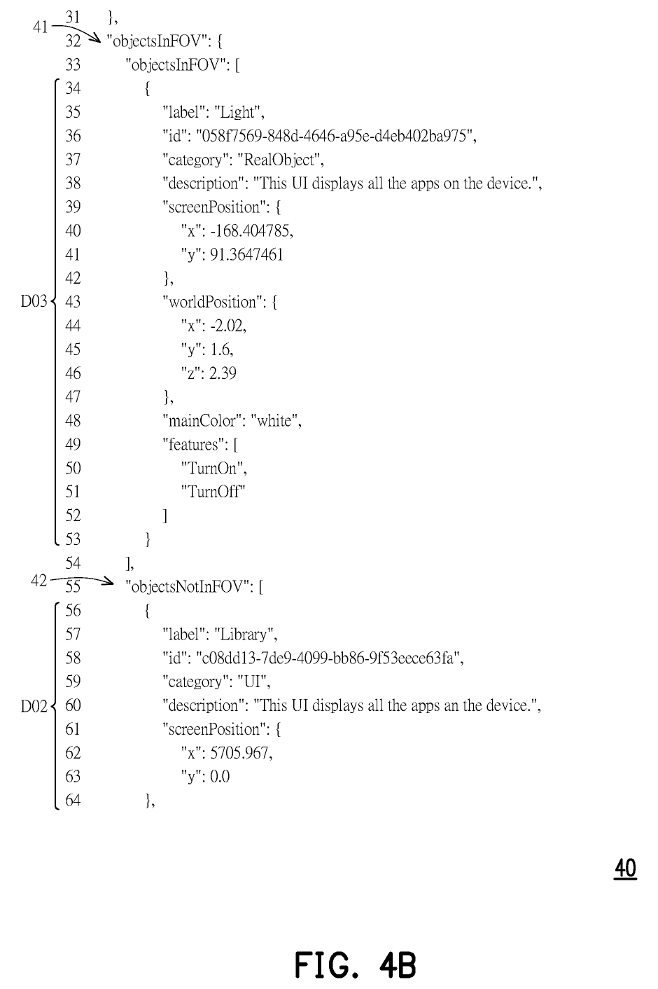

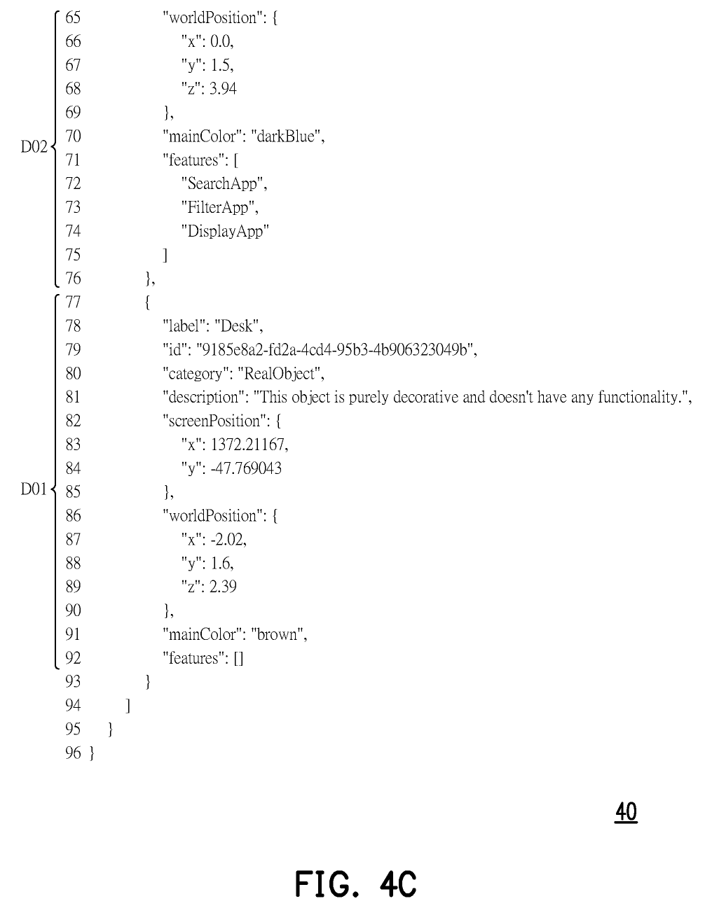

For better understanding, FIGS. 4A to 4C would be used as an example, wherein FIGS. 4A to 4C collectively shows a schematic diagram of different segments of the second descriptor file according to a second embodiment of the disclosure.

In the second embodiment, the objects in the virtual environment may be the same as in the first embodiment, which may include the desk object, the library object, and the light object. In the scenario of FIGS. 4A to 4C, it is assumed that the current field of view has been changed from the first field of view considered in FIGS. 3A to 3C to a second field of view, and the considered second objects in the second field of view may be assumed to merely include the light object. That is, the desk object and the library object is assumed to be currently not in the field of view, but the disclosure is not limited thereto.

In this case, the processor 104 may integrate the descriptor D03 of the light object into the second descriptor file 40, which may be a JSON file.

Specifically, as can be seen from FIGS. 4B and 4C, the second descriptor file 40 may include a first set 41 and a second set 42, wherein the first set 41 indicates the light object in the second field of view, and the second set 42 indicates the desk object and the library object not in the second field of view.

In the embodiment, the first set 41 may include the descriptor D03, and the second set 42 may include the descriptors D01 and D03.

In some embodiments, the second descriptor file 40 may not include the second set 42, but the disclosure is not limited thereto.

Next, in response to determining that a second voice input associated with the second field of view has been detected, the processor 104 may provide a second response with respect to the second voice input based on the second descriptor file. The concept of this operation is similar to step S250, and hence the associated details may be referred to the descriptions of FIG. 2, which would not be repeated herein.

The disclosure further provides a computer readable storage medium for executing the method for providing interactive response. The computer readable storage medium is composed of a plurality of program instructions (for example, a setting program instruction and a deployment program instruction) embodied therein. These program instructions can be loaded into the host 100 and executed by the same to execute the method for providing interactive response and the functions of the host 100 described above.

In summary, the embodiments of the disclosure provide a solution to dynamically determine an integrated descriptor file based on the descriptors of the objects currently in the field of view. When an input voice corresponding to the current field of view is detected, the solution may determine the associated response based on the integrated descriptor file. Since the solution of the disclosure does not involve any image recognition, the process of image uploading and recognizing can be omitted.

In addition, since the integrated descriptor file can be understood as a descriptor file associated with the scene currently in front of the user, the first response may be inferred with a better accuracy and efficiency.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A method for providing interactive response, executed by a host, comprising:
providing a virtual environment, wherein the virtual environment comprises a plurality of objects, and each of the plurality of objects has a corresponding descriptor;
detecting a first field of view in the virtual environment, wherein the first field of view is a current field of view;
determining, among the plurality of objects, a plurality of first objects in the first field of view;
integrating the corresponding descriptor of each of the plurality of first objects into a first descriptor file corresponding to the first field of view; and
in response to determining that a first voice input associated with the first field of view has been detected, providing a first response with respect to the first voice input based on the first descriptor file.

2. The method according to claim 1, further comprising:
in response to determining that the current field of view has been changed from the first field of view to a second field of view, determining, among the plurality of objects, a plurality of second objects in the second view of view;
integrating the corresponding descriptor of each of the plurality of second objects into a second descriptor file; and
in response to determining that a second voice input associated with the second field of view has been detected, providing a second response with respect to the second voice input based on the second descriptor file.

3. The method according to claim 1, wherein providing the first response with respect to the first voice input based on the first descriptor file comprises:
generating a first prompt combination at least based on the first descriptor file and the first voice input; and
inputting the first prompt combination to a virtual assistant to trigger the virtual assistant to provide the first response.

4. The method according to claim 3, wherein generating the first prompt combination at least based on the first descriptor file and the first voice input comprises:
generating the first prompt combination based on the first descriptor file, the first voice input, and a pre-prompt, wherein the pre-prompt requests to answer the first voice input based on the first descriptor file.

5. The method according to claim 3, wherein the virtual assistant is triggered to provide the first response by executing a first function requested by the first voice input.

6. The method according to claim 5, wherein the first prompt combination further comprises an indicator position of an input indicator in the first field of view, the first voice input requests to control a target object among the plurality of first objects, and the virtual assistant is triggered to perform:
determining the target object by parsing the first descriptor file based on the indicator position; and
executing the first function by controlling the target object as requested by the first voice input.

7. The method according to claim 6, wherein the target object is closest to the indicator position among the plurality of first objects.

8. The method according to claim 1, wherein the corresponding descriptor of a particular object of the plurality of objects comprises at least one of following information of the particular object:
a label, an identification, a category, a description, a world position, a main color, a feature, wherein the world position indicates a position of the particular object in the virtual environment.

9. The method according to claim 1, wherein the first descriptor file comprises at least one of following information of each of the first objects:
a label, an identification, a category, a description, a screen position, a world position, a main color, a feature, wherein the screen position of each of the plurality of first objects indicates a position of each of the plurality of first object with respect to a reference point in the first field of view, and the world position of each of the plurality of first objects indicates a position of each of the plurality of first object in the virtual environment.

10. The method according to claim 6, wherein the first descriptor file further comprises a first set indicating the plurality of first objects in the first field of view, and a second set indicating other objects not in the first field of view.

11. A host, comprising:
a non-transitory storage circuit, storing a program code; and
a processor, coupled to the non-transitory storage circuit and configured to access the program code to perform:
providing a virtual environment, wherein the virtual environment comprises a plurality of objects, and each of the plurality of objects has a corresponding descriptor;
detecting a first field of view in the virtual environment, wherein the first field of view is a current field of view;
determining, among the plurality of objects, a plurality of first objects in the first field of view;
integrating the corresponding descriptor of each of the plurality of first objects into a first descriptor file corresponding to the first field of view; and
in response to determining that a first voice input associated with the first field of view has been detected, providing a first response with respect to the first voice input based on the first descriptor file.

12. The host according to claim 11, wherein the processor is further configured to perform:
in response to determining that the current field of view has been changed from the first field of view to a second field of view, determining, among the plurality of objects, a plurality of second objects in the second view of view;
integrating the corresponding descriptor of each of the plurality of second objects into a second descriptor file; and
in response to determining that a second voice input associated with the second field of view has been detected, providing a second response with respect to the second voice input based on the second descriptor file.

13. The host according to claim 11, wherein the processor is configured to perform
generating a first prompt combination at least based on the first descriptor file and the first voice input; and
inputting the first prompt combination to a virtual assistant to trigger the virtual assistant to provide the first response.

14. The host according to claim 13, wherein the processor is configured to perform
generating the first prompt combination based on the first descriptor file, the first voice input, and a pre-prompt, wherein the pre-prompt requests to answer the first voice input based on the first descriptor file.

15. The host according to claim 13, wherein the virtual assistant is triggered to provide the first response by executing a first function requested by the first voice input.

16. The host according to claim 15, wherein the first prompt combination further comprises an indicator position of an input indicator in the first field of view, the first voice input requests to control a target object among the plurality of first objects, and the virtual assistant is triggered to perform:
determining the target object by parsing the first descriptor file based on the indicator position; and
executing the first function by controlling the target object as requested by the first voice input.

17. The host according to claim 16, wherein the target object is closest to the indicator position among the plurality of first objects.

18. The host according to claim 11, wherein the corresponding descriptor of a particular object of the plurality of objects comprises at least one of following information of the particular object:
a label, an identification, a category, a description, a world position, a main color, a feature, wherein the world position indicates a position of the particular object in the virtual environment.

19. The host according to claim 11, wherein the first descriptor file comprises at least one of following information of each of the first objects:
a label, an identification, a category, a description, a screen position, a world position, a main color, a feature, wherein the screen position of each of the plurality of first objects indicates a position of each of the plurality of first object with respect to a reference point in the first field of view, and the world position of each of the plurality of first objects indicates a position of each of the plurality of first object in the virtual environment;
wherein the first descriptor file further comprises a first set indicating the plurality of first objects in the first field of view, and a second set indicating other objects not in the first field of view.

20. A non-transitory computer readable storage medium, the computer readable storage medium recording an executable computer program, the executable computer program being loaded by a host to perform steps of:
providing a virtual environment, wherein the virtual environment comprises a plurality of objects, and each of the plurality of objects has a corresponding descriptor;
detecting a first field of view in the virtual environment, wherein the first field of view is a current field of view;
determining, among the plurality of objects, a plurality of first objects in the first field of view;
integrating the corresponding descriptor of each of the plurality of first objects into a first descriptor file corresponding to the first field of view; and
in response to determining that a first voice input associated with the first field of view has been detected, providing a first response with respect to the first voice input based on the first descriptor file.
